(19) United States
(12) Patent Application Publication
(10) Pub. No.: US 2026/0103550 A1
(43) Pub. Date: Apr. 16, 2026

(54) OXIDATIVE FUNCTIONALIZATION OF POLYOLEFINS USING OZONE

(71) Applicant: University of Kansas, Lawrence, KS (US)

(72) Inventors: Hongda Zhu, Lawrence, KS (US); Timothy A. Jackson, Lawrence, KS (US); Bala Subramaniam, Lawrence, KS (US)

(21) Appl. No.: 19/238,887

(22) Filed: Jun. 16, 2025

Related U.S. Application Data
(60) Provisional application No. 63/660,740, filed on Jun. 17, 2024.

(51) Int. Cl. C08F 8/06; C08F 6/00; C08F 10/02; C08F 10/06

(52) U.S. Cl. CPC C08F 8/06; C08F 6/008; C08F 10/02; C08F 10/06; C08F 2500/07

(57) ABSTRACT

Provided are processes for the oxidative functionalization of polyolefins by ozone. Such a process may comprise exposing a polyolefin to an alkane swelling agent under conditions to form a pretreated polyolefin; and exposing the pretreated polyolefin to ozone under conditions to oxidize the pretreated polyolefin to form a functionalized polyolefin.

### CROSS REFERENCE TO RELATED APPLICATIONS

The present application claims priority to U.S. Provisional Patent Application No. 63/660,740, filed Jun. 17, 2024, the entire contents of which is incorporated herein by reference.

### REFERENCE TO GOVERNMENT RIGHTS

This invention was made with government support under 2119754 awarded by the National Science Foundation. The government has certain rights in the invention.

### BACKGROUND

The production of polyolefins, including polyethylene and polypropylene, contributes to more than 50% of non-fiber synthetic plastics, at a scale of over 150 million tons per year globally. While most of these are single-use plastics and end up in landfill, incinerator, or oceans, they can be potentially recycled as feedstock. The post-polymerization functionalization of polyolefins is a route to modify the properties of virgin materials or to repurpose post-consumer materials. Introduction of functional groups, such as carbonyls and hydroxyls, may also facilitate photo-oxidative and enzymatic deconstruction of the polyolefins.

### SUMMARY

Provided are processes for the oxidative functionalization of polyolefins by ozone. Although ozone is a powerful oxidant for some hydrocarbon materials, polyolefins present a particularly challenging substrate, e.g., as compared to small molecule alkanes. For example, functionalization of the plurality of stable C—H bonds in polyolefins is greatly hindered by the impermeability of these semi-crystalline polymeric materials. Melting polyolefins can be accomplished using relatively high temperatures, but many oxidants, including ozone, can decompose rapidly at such temperatures. The present processes are based, at least in part, on the discovery of a pretreatment step that leads to unexpectedly high levels of functionalization (e.g., with carbonyl groups) of polyolefins, including polyethylene, by ozone. The processes are illustrated by reference to Examples below, demonstrating the successful functionalization of high-density polyethylene by ozone with carbonyl and carboxylic acid groups.

In an embodiment, a process for functionalizing a polyolefin comprises exposing a polyolefin to an alkane swelling agent under conditions to form a pretreated polyolefin; and exposing the pretreated polyolefin to ozone under conditions to oxidize the pretreated polyolefin to form a functionalized polyolefin.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1. IR absorbance of scCO₂-pretreated HDPE samples before and after ozone treatment at various conditions in CO₂.

FIG. 2. IR absorbance of isobutane-pretreated HDPE samples before and after ozone treatment in liquid CO₂ at various conditions.

FIG. 3. IR absorbance of hexane-pretreated HDPE samples before and after ozone treatment in liquid CO₂ at various conditions.

FIG. 4. Proton NMR spectra of soluble products from ozonized HDPE samples subject to hexane pretreatment.

FIG. 5. Solid-state ¹H NMR spectra of ozonized HDPE samples subject to hexane pretreatment at 120° C. and 0.41 MPa.

FIG. 6. Solid-state ¹³C NMR with ¹H decoupling (hpdec) spectra of ozonized HDPE samples subject to hexane pretreatment at 120° C. and 0.41 MPa.

FIG. 7. Solid-state ¹³C{¹H} cross-polarization (cp) NMR spectra of ozonized HDPE samples subject to hexane pretreatment at 120° C. and 0.41 MPa. The asterisks represent the spinning side bands.

FIG. 8. Solid-state ¹³C{¹H} non-quaternary-suppression cross-polarization (cpnqs) NMR spectra of ozonized HDPE samples subject to hexane pretreatment at 120° C. and 0.41 MPa.

FIG. 9. IR absorbance of hexane-pretreated HDPE samples during gas-solid ozonation.

FIG. 10. Images of untreated and hexane-treated HDPE samples at 2× (optical microscope), 500× and 10,000× (SEM with secondary electron detectors) magnification. All images are scaled to an identical PPI (pixels-per-inch).

FIG. 11. N₂ adsorption isotherms on empty (empty markers) and loaded (solid markers) sample cells. The volumes adsorbed on the surfaces of empty cells and the corresponding volumes adsorbed when loaded with the samples are shown for comparison.

FIG. 12. Molecular weight distributions of the untreated HDPE substrate (trace A) and solvent-pretreated and ozonized HDPE samples (traces B-D). The ozone-treated samples (traces B, C, and D) correspond to those in rows 3, 5 and 6 in Table 2, respectively.

### DETAILED DESCRIPTION

Provided are processes for the oxidative functionalization of polyolefins by ozone. The processes comprise pretreating a polyolefin to provide a pretreated polyolefin, followed by an ozonation step to oxidize the pretreated polyolefin to provide a functionalized polyolefin.

“Polyolefin” refers to a class of hydrocarbon polymers which have been formed by polymerizing olefin monomers, such as α-olefin monomers. Illustrative polyolefins include polyethylene (polymerized ethylene), polypropylene (polymerized propylene), polyisobutylene. Similar macromolecules containing C—H bonds in the polymer chain may be used. The polyolefin may be a saturated polyolefin free of carbon-carbon double bonds. The polyolefin may be unsubstituted, i.e., comprising only hydrogen and carbon. However, in embodiments, the polyolefin may be substituted, including by including crosslinker functional groups comprising elements other than carbon and hydrogen, e.g., Si, B. The polyolefin may be characterized by its density, degree of branching, degree of crystallinity, tacticity, and molecular weight. Regarding molecular weight, the polyolefin may have a weight average molecular weight M_{w} in a range of from 10³ to 10⁶ Da or from 10⁴ to 10⁶ Da. In embodiments, the polyolefin is a homopolymer. However, copolymers may be used, including a copolymer of ethylene and propylene. Illustrative polyethylenes include high-density polyethylene (HDPE), low density polyethylene (LDPE), linear low-density polyethylene (LLDPE), very low-density polyethylene (VLDPE), and ultra-high molecular weight polyethylene (UHMWPE). The polypropylene may be high-density polypropylene (HDPP), low-density polypropylene (LDPP), atactic polypropylene, syndiotactic polypropylene, and isotactic polypropylene. A single type or a combination of different types of polyolefins may be used. The polyolefin(s) may be provided as a polyolefin feedstock comprising other components, e.g., polyolefin fragments, crosslinkers, crosslinker fragments, polymerization catalysts, additives, dyes, which may be inherently present in the specific source of the feedstock.

The pretreatment step comprises exposing the polyolefin to an alkane swelling agent. The alkane swelling agent is a saturated hydrocarbon. The alkane swelling agent is generally unsubstituted. The alkane swelling agent may have various numbers of carbons, e.g., from 3 to 20. This includes from 3 to 18, from 3 to 16, from 3 to 14, from 3 to 12, from 3 to 10, and from 3 to 8. Other ranges between any of these values may also be used. Linear alkane swelling agents may be used, in which case all the carbons are in an unbranched (linear) chain. However, branched and cyclic alkane swelling agents may be used. The alkane swelling agent is desirably in its liquid phase under the conditions being used in the pretreatment step, although there may be some of amount of the alkane swelling agent present in a vapor phase above such a liquid phase. Illustrative alkane swelling agents include propane, butane, pentane, hexane. Other illustrative alkane swelling agents include cyclohexane, cyclopentane, methyl-cyclohexane, other alkyl-cyclohexanes, and decalin. Unless otherwise identified, the alkane swelling agent refers to each isomer thereof, e.g., “butane” refers to isobutane and n-butane. A single type or a combination of different types of alkane swelling agents may be used. This includes mixtures of branched and cyclic alkane swelling agents. The alkane swelling agent(s) may be provided as a pretreatment medium comprising other components. However, in embodiments, only the alkane swelling agent(s) are present such that the pretreatment medium consists of the alkane swelling agent(s) and the polyolefin(s) therein.

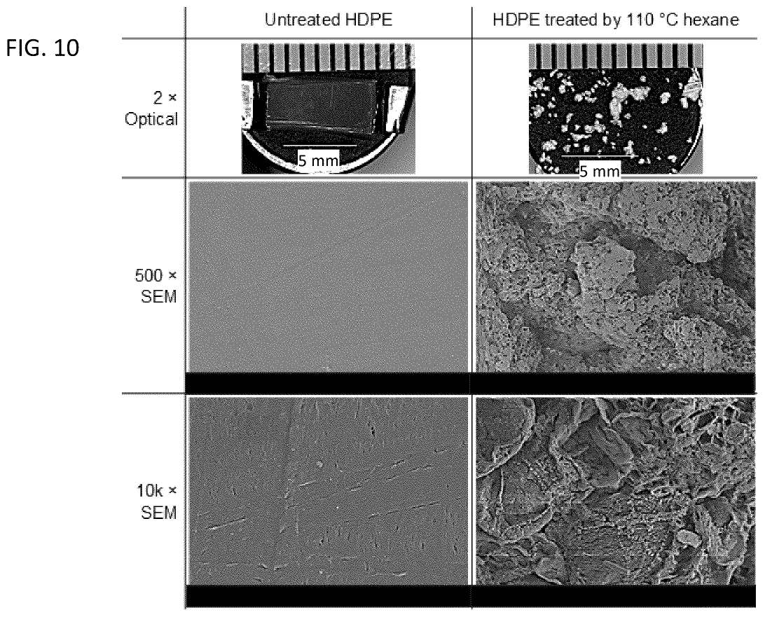

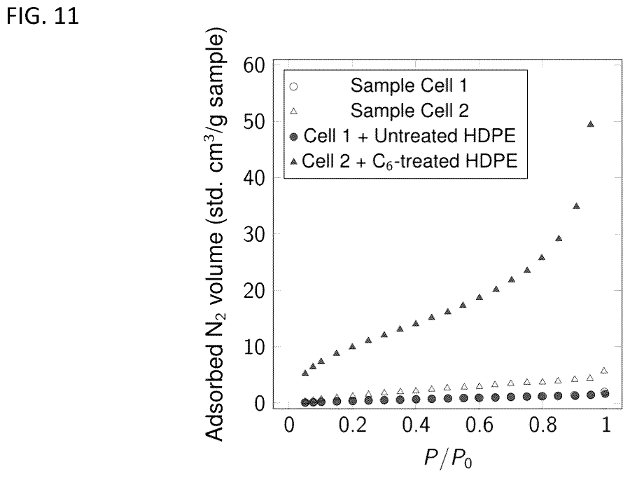

The conditions under which the polyolefin is exposed to the alkane swelling agent are generally selected to facilitate the swelling of the polyolefin. The term “swelling” is used in reference to various changes in the intermolecular structure (as opposed to the intramolecular structure which generally remains intact) of the polyolefin that increase the accessibility of the polyolefin to its surrounding medium. The amount of swelling may be quantified by reference to an increase in dimensions or porosity of the polyolefin after the pretreatment step as compared to the polyolefin's porosity prior to the pretreatment step. Increased porosity may be confirmed from scanning electron microscope images such as those shown in FIG. 10. Nitrogen sorption may also be used to confirm an increased surface area for pretreated polyolefin due to increased porosity as compared to the polyolefin's surface area prior to the pretreatment step. (See FIG. 11.) In some embodiments, it may be desirable to maximize the extent of swelling/porosity to increase access of the pretreated polyolefin by ozone to increase the degree of functionalization and C—C bond scission (leading to shorter chain, smaller molecular weight functionalized polyolefin). However, in other embodiments, less swelling/porosity may be preferred to limit access, functionalization, and C—C-bond scission. Thus, the pretreatment conditions allow for tuning of the desired functionalized polyolefin, including its degree of functionalization, type of functionalization, and molecular weight.

These conditions under which the polyolefin is exposed to the alkane swelling agent may refer to a pretreatment temperature and a pretreatment pressure. The specific values of these parameters depend upon the polyolefin and the alkane swelling agent being used (as well as the desired functionalized polyolefin), but generally, the pretreatment temperature is greater than room temperature (20° C. to 25° C.) and the pretreatment pressure is greater than atmospheric pressure (14.5 psia, 0.1 MPa). In embodiments, the pretreatment temperature is greater than room temperature but less than the melting temperature of the polyolefin in the absence of the alkane swelling agent. Using HDPE as an example, the pretreatment temperature may be in a range of from 100° C. to 170° C., from 100° C. to 160° C., from 100° C. to 125° C., from 105° C. to 125° C., or from 110° C. to 120° C. Other ranges between any of these values may also be used. In embodiments, the pretreatment pressure corresponds to the vapor pressure of the selected alkane swelling agent at the selected pretreatment temperature. In embodiments, the pretreatment pressure is at least 0.2 MPa, at least 0.3 MPa, at least 0.4 MPa, at least 1 MPa, at least 2 MPa, at least 3 MPa, or in a range of from 0.2 MPa to 5 MPa. Other ranges between any of these values may also be used.

Another condition of the pretreatment step may refer to a pretreatment time that the polyolefin and the alkane swelling agent are exposed to each other at the selected pretreatment temperature and pressure. Illustrative pretreatment times include, e.g., from 1 hour to 10 hours, from 2 hours to 8 hours, or from 2 hours to 6 hours. Other ranges between any of these values may also be used.

Another condition of the pretreatment step may refer to the relative amounts of polyolefin and alkane swelling agent being used. In embodiments, the polyolefin and the alkane swelling agent are present at a (polyolefin)/(alkane swelling agent) weight ratio of at least 0.01, at least 0.1, at least 1, or in a range of from 0.01 to 1 or from 0.1 to 1. Other ranges between any of these values may also be used. If more than one type of polyolefin and/or more than one type of alkane swelling agent are used, these amounts refer to total respective amounts.

The result of the pretreatment step is a pretreated polyolefin. As noted above, this pretreated polyolefin is porous. This includes the pretreated polyolefin having a porosity that is at least 25 times greater, 50 times greater, 100 times greater, 1,000 times greater, 10,000 times greater, or a range of between any of these values, than that of the polyolefin prior to pretreatment, which may be confirmed using N₂ sorption experiments. The untreated polyolefin may be considered to be non-porous as confirmed using N₂ sorption experiments (i.e., N₂ sorption below a detection limit).

After pretreatment and before the ozonation step, the alkane swelling agent is generally removed. In addition, the pretreated polyolefin may be cooled (e.g., back to room temperature). Removal of the alkane swelling agent may be carried out by evaporation under ambient conditions, heating under vacuum, etc. Generally, substantially all of the alkane swelling agent is removed from the pretreated polyolefin prior to ozonation, and can be collected for reuse. The swelling of the polyolefin achieved during the pretreatment step is maintained after removal of the alkane swelling agent and cooling. In other words, the pretreated polyolefin does not recrystallize (i.e., the swelling is irreversible), rendering the intermolecular structure of the pretreated polyolefin accessible to the ozone used in the subsequent ozonation. As noted above and demonstrated in the Examples below, the swelling achieved by alkane swelling agents results in unexpectedly high levels of functionalization as compared to using other additives e.g., CO₂, water, acetic acid, NaOH.

Next, the present processes further comprise ozonation of the pretreated polyolefin. The ozonation step comprises exposing the pretreated polyolefin to ozone. The ozone may be provided as ozonation medium comprising other components, e.g., gases used to deliver the ozone such as O₂, an inert gas(es). In embodiments, only ozone (and any other inert gases used to deliver the ozone) is used such that the ozonation medium consists of the ozone, the pretreated polyolefin therein, and optionally, O₂, inert gas(es), or both. In such embodiments, the oxidation generally takes place at a solid (pretreated polyolefin)-gas (gas phase ozonation medium) interface. Note that electrolytic oxygen, a byproduct of electrolytic water splitting by renewable energy in hydrogen hubs, may be used to produce green ozone.

In other embodiments, the ozonation step additionally involves CO₂, i.e., the ozonation medium comprises ozone (and any other gases used to deliver the ozone) and CO₂. In such embodiments, the ozonation medium comprises (or consists of) the ozone, CO₂, the pretreated polyolefin therein, and optionally, O₂, inert gas(es), or both. The CO₂ may be in its liquid phase, i.e., liquid CO₂ (liqCO₂), which provides a liquid phase medium for solubilizing the ozone and solubilizing/suspending the pretreated polyolefin. In such embodiments, the oxidation generally takes place at a solid (pretreated polyolefin)-liquid (liquid phase medium) interface. In other embodiments, the CO₂ may be in its supercritical phase, i.e., supercritical CO₂ (scCO₂).

Although no catalyst is required for the ozonation step, in other embodiments including those described above, a catalyst may be used (i.e., the ozonation medium may comprise a catalyst). If a catalyst is used, the catalyst may contain transition metals or their combinations, such as a first-row transition metal (e.g., Fe, Co, Ni) and/or a platinum group metal, e.g., Ru, Pd, Pt. The catalyst may be supported transition metal catalyst in which the selected transition metal is incorporated into or deposited on a surface of a metal oxide substrate, e.g., an oxide of aluminum, silicon, titanium, magnesium, cerium, zirconium, etc. or two-dimensional materials such as graphene or hexagonal boron nitride. Illustrative metal oxide substrates include silicates and zeolites. Mesoporous silicates such as KIT-5, KIT-6, SBA-16, TUD-1 may be used.

It is to be understood that in reference to any of the ozonation media described above as “consisting” of certain components, such components may also include the presence of the products resulting from the oxidation of the pretreated polyolefin, i.e., the functionalized polyolefin. These products are further described below.

The conditions under which the pretreated polyolefin is exposed to the ozone are generally selected to facilitate the oxidation of C—H bonds of the polyolefin and also depend upon the desired functionalized polyolefin as described above with respect to the pretreatment step. These conditions may refer to an ozonation temperature and an ozonation pressure. The specific values of these parameters depend upon the pretreated polyolefin as well as the presence (and phase) of the CO₂. For embodiments in which CO₂ is not used, and for embodiments in which liquid CO₂ is used, the ozonation temperature may be in a range of from 15° C. to 130° C., 15° C. to 60° C., 15° C. to 50° C., 15° C. to 40° C., 15° C. to 30° C., and 15° C. to 25° C. Other ranges between any of these values may also be used. For embodiments in which supercritical CO₂ is used, the ozonation temperature may be greater than the critical temperature of CO₂ (about 31.1° C.), including higher such temperatures within the ranges disclosed above.

For embodiments in which CO₂ is not used, the ozonation pressure may refer to the total pressure of the ozone (and any other gases used to deliver the ozone) at the selected temperature. In such embodiments, the ozonation pressure may be in a range of from 0.001 MPa to 0.5 MPa, from 0.01 MPa to 0.5 MPa, and from 0.1 MPa to 0.5 MPa. Other ranges between any of these values may also be used. For embodiments in which liquid CO₂ is used, the ozonation pressure may refer to a total pressure of the vapor phase present above, and in contact with, the liquid phase medium at the selected temperature. This vapor phase comprises ozone (and any other gases used to deliver the ozone). In other embodiments, the ozonation pressure may refer to the total pressure above a liquid CO₂ phase wherein the ozone (and any other gases used to deliver the ozone are completely dissolved). In these embodiments, the total pressure may be greater than atmospheric pressure but less than 10 MPa. This includes from 0.4 MPa to 10 MPa, and from 1 MPa to 8 MPa. Other ranges between any of these values may also be used. For embodiments in which supercritical CO₂ is used, the ozonation pressure may refer to a total pressure of the ozone (and any other gases used to deliver the ozone) and the CO₂. In such embodiments, the total pressure may be greater than the critical pressure of CO₂ (about 7.4 MPa), including higher such pressures within the ranges disclosed above.

Another condition of the ozonation step may refer to the mole fraction of ozone being used, i.e., the O₃/(ozone+and any other gases used to deliver the ozone) mole fraction. Illustrative ozone mole fractions include from 0.5% to 4%, from 1% to 10%, from 2% to 8%, and from 2% to 4%. Other ranges between any of these values may also be used. If liquid CO₂ is used, at least some of this ozone will be solubilized into the liquid CO₂, the specific amount depending upon the selected ozonation temperature and ozone partial pressure.

The present processes may be carried out in a variety of reactor systems, including batch reactor systems, semi-continuous flow reactor systems, and continuous flow reactor systems. If a solid catalyst is used, the processes may be carried out in fixed-bed and fluidized-bed systems. Reactor systems in which gas (e.g., ozone) and liquid (e.g., liquid CO₂) phases may be continuously admitted and withdrawn are useful to achieve better control of reactor temperature and product yield in this exothermic reaction system.

The products obtained from the ozonation step depend upon the selected pretreated polyolefin as well as the ozonation conditions used. However, in embodiments, oxidation comprises conversion of C—H bonds to carbonyl (C═O) groups within the pretreated polyolefin to provide a carbonyl functionalized polyolefin. The degree of conversion may be quantified by reference to a carbonyl index as described in the Examples below. In embodiments, the carbonyl functionalized polyolefin exhibits a carbonyl index of at least 0.8. This includes a carbonyl index of at least 0.9, at least 1.0, at least 1.2, at least 1.4, at least 1.6, and at least 2.5. Other ranges between any of these values may also be used. A greater carbonyl index indicates a greater degree of functionalization. The carbonyl indices may be reported with reference to a particular set of ozonation conditions used in the process (including the sets of ozonation conditions described in the Examples, below).

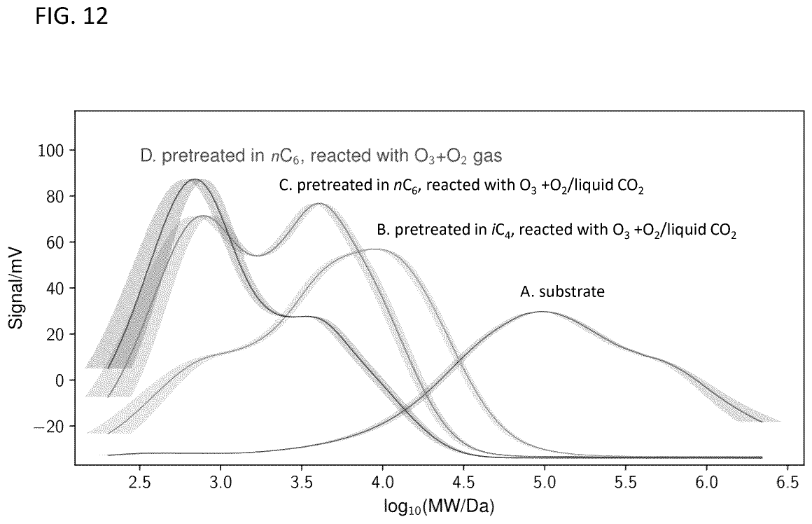

Other functional groups that may be present in the functionalized polyolefin due to oxidation include hydroperoxyl, hydroxyl, and carboxyl groups. Other indices analogous to the carbonyl index may also be used to quantify the formation of such functional groups in the pretreated polyolefin due to oxidation. Regarding carboxyl groups, Example 2 provides evidence of carboxylic acid group functionality as well as C—C scission to provide shorter chain, smaller molecular weight functionalized polyolefin (as compared to untreated, unoxidized polyolefin). (Untreated, unoxidized refers to polyolefin that has not been subjected to the disclosed pretreatment and ozonation steps.) In particular, FIG. 12 shows how the conditions of the pretreatment step and the ozonation step may be selected to tune the molecular weight distribution of the functionalized polyolefin, demonstrating the flexibility of the present processes. Further regarding molecular weight, the functionalized polyolefin generally exhibits a M_{w} that is less than that of the untreated, unoxidized polyolefin. This includes 10 times less, 15 times less, 20 times less, 50 times less, 100 times less, 200 times, 500 times less, 1000 times less, and a range between any of these values.

The present processes may further comprise additional steps, e.g., recovering the functionalized polyolefin(s) from the ozonation medium, using the functionalized polyolefin(s), e.g., in chemical reactions to form other products.

### EXAMPLES

### Example 1

This Example demonstrates the ozonation of a post-consumer polyethylene (PE) material that was first subjected to a pretreatment step. Untreated PE (i.e., PE not subjected to the pretreatment step) showed negligible susceptibility to oxidation by ozone. By contrast, the pretreated PE significantly promoted the oxidative functionalization of secondary C—H bonds therein at ambient temperatures to produce carbonyl groups. The dramatically increased ozone reactivity in pretreated PE is attributed to its irreversible swelling during the pretreatment step.

### Materials

The n-butane (chemically pure), isobutane (ultrahigh purity), and carbon dioxide (research purity) were purchased from Matheson. The hexane (C₆H₁₄ isomers >99%, n-hexane >95%) was purchased from Sigma-Aldrich. The alkanes and carbon dioxide were used without further purification. The high-density polyethylene (HDPE) materials (up to 0.7 mm thick) were obtained from the containers of Walmart and Kroger branded distilled water. The containers were cleaned with a metal brush and Alconox detergent to remove the labels and possible contaminants on the surface, and then washed with water and acetone. Negligible differences were observed from the FTIR spectra of the cleaned and pretreated materials from the two sources. The results and discussion section below refer to representative spectra from the Kroger branded containers.

### Experimental Methods

Pretreatment. Experiments were performed in a 50 mL 4590 Series Parr reactor rated to 3000 psi and 350° C. For pretreatment, the HDPE sheets were cut into pieces less than 0.3 cm², and about 0.2 g was loaded into the reactor. Next, the pretreatment medium [either hexane, isobutane, n-butane or supercritical carbon dioxide (scCO₂)] was introduced into the loaded reactor. For hexane pretreatment, ˜30 mL liquid was loaded into the reactor prior to attaching to the reactor head. For isobutane, n-butane, and carbon dioxide pretreatment (which are gases at ambient conditions), the respective pretreatment medium was charged into the reactor in its liquid phase using a cooled ISCO syringe pump (10° C.) after the reactor was assembled. Next, the reactor contents were heated to the desired temperature with stirring at 600 rpm, and then held at this temperature for a desired time. Immediately after the heater was switched off, the heating jacket was removed and the reactor was quenched by ice to ˜50° C. within 5 min. Next, for hexane, isobutane, and n-butane pretreated samples, the pretreatment medium was removed from the reactor. For hexane pretreated samples, the resulting samples were filtered and the hexane was allowed to vaporize naturally. For hexane, isobutane, and n-butane pretreated samples, the resulting samples were also heated to 60° C. under vacuum for 4 h to remove any dissolved alkanes. For scCO₂ pretreated samples, the pretreatment medium was not removed.

Ozonation. For ozonation, the pretreated HDPE samples were loaded back into the Parr reactor after removal of the pretreatment media (not necessary for scCO₂ pretreated samples). When using liquid carbon dioxide (liqCO₂) as the ozonation medium, a desired amount of ozone/dioxygen mixture was charged into an external reservoir, and then a desired amount of carbon dioxide was charged as gas. The ozone/dioxygen/carbon dioxide mixture was then injected into the reactor with the cooled syringe pump. When using scCO₂ as the ozonation medium, the CO₂ was pumped as a liquid into the reactor using an ISCO pump in the constant pressure mode to allow the reactor content to equilibrate at the desired temperature and pressure (50° C., 1150 psia or 7.9 MPa). Then a fraction of the CO₂ was discharged into an ISCO pump to free up volume in the reactor to be filled by an ozone/dioxygen/CO₂ mixture. The discharged CO₂ was condensed to ˜10 mL in the ISCO pump at 6.9 MPa (1000 psia) and 10° C. The mixture of ozone/dioxygen/CO₂ was charged into the reactor using another ISCO pump. For gas-solid ozonation (i.e., no CO₂ media used), the ozone/dioxygen mixture was simply charged into the closed reactor using the syringe pump. In each case, the ozonation reaction was allowed to proceed for a certain period of time (4 h) and then methanol was added to the reactor to dissolve any small-molecule products that may have formed.

Characterization. Samples were pressed into thin films of around 0.1-0.2 mm using a Wabash hydraulic press for performing transmission FTIR. A small quantity was placed in the mold that nearly covered the 8 mm bottom die. The mold was held under 56-58 MPa until the pressure changed negligibly over a 30 min duration. The spectra were collected using a Bruker Tensor 27 spectrometer equipped with a MCT detector, with an aperture size of 0.25 mm. The transmittance spectra were converted to absorbance and normalized to the film thickness measured by calipers. Determination of carbonyl indices was carried out as described below.

The ¹H NMR spectra of the methanol-dissolved products were collected on a Bruker Avance III HD 400 MHz spectrometer. The solid-state NMR spectra of the solid samples were collected on a Bruker Avance III 400 MHz spectrometer with magic angle spinning (MAS) at 5 kHz unless otherwise mentioned. For ¹H NMR, the “onepulse” pulse program was used. For ¹³C NMR using the “hpdec” pulse program, a recycle delay of 30 s was used. For the “cp” and “cpnqs” pulse programs, a recycle delay of 4 s and a contact time of 1 ms were used.

### Results and Discussion

Attempts with Semi-Crystalline HDPE

Prior to the experiments which showed successful functionalization, various attempts were made to ozonize untreated semi-crystalline HDPE (i.e., no pretreatment step was used) by exposure to O₃ under various conditions as set forth below. Samples as small as ˜2×0.7×0.7 mm³ were tested. In all cases, no products soluble in water, methanol, or chloroform were detected. In all cases, no functionalization of the solid samples was observed in their respective FTIR spectra. In one set of initial experiments, in a glass reactor at ambient pressure with magnetic stirring at 600 rpm, a mixture of 3.4 mol % O₃ in O₂ was continuously bubbled through the following: samples suspended in water, at 22° C. and 50° C.; samples suspended in acetic acid, 22° C.; samples suspended in an acetic acid/water mixture (1:1 v/v), 22° C.; and samples suspended in NaOH/water (pH≈10), 22° C. In another set of initial experiments, in a stainless-steel Parr reactor around 50 psia (0.35 MPa), with mechanical stirring at 800 rpm, a mixture of 3.4 mol % O₃ in O₂ was continuously bubbled through the following: samples suspended in water, at 22° C. and 50° C.; and samples suspended in NaOH/water (pH≈10), 22° C.

### Ozonation Following Pretreatment in Supercritical Carbon Dioxide

In another experiment involving a comparative pretreatment step, in a stainless-steel Parr reactor, with mechanical stirring at 800 rpm, a semi-crystalline HDPE sample was pretreated in scCO₂ at 70° C., 1500 psia (10.3 MPa), and 4 h. Next, the CO₂ was partially displaced by a O₃/O₂/CO₂ mixture for reaction in batch mode using the same procedure above in [0038]. The HDPE pretreated and ozonated in this manner remained semi-crystalline and semi-transparent as the un-pretreated sample. No oxidation products were detected in this run.

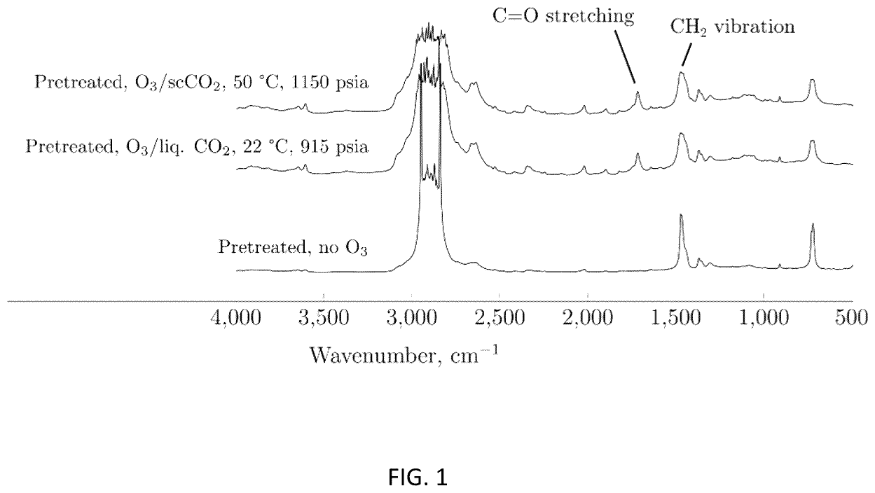

However, the HDPE deformed, swelled, and showed less transparency after being pretreated in scCO₂ at ˜1500 psia (10.3 MPa) and 120° C. for 4 h. This pretreated HDPE sample (˜50 mg) was loaded into the reactor for ozonation in either scCO₂ or liqCO₂. In each case, the reactor was charged with 3.2±0.2 mmol ozone and 30.9±2.1 mmol dioxygen. After 4 h following the introduction of the ozone/dioxygen mixture, no ozone was detected when the carbon dioxide was discharged. No soluble products could be detected by proton NMR from the methanol wash. However, in the solid sample, formation of carbonyl groups was evidenced in the FTIR spectra (FIG. 1) as compared to the pretreated sample that was not exposed to ozone. Reaction temperatures of 22 and 50° C. led to a similar degree of ozonation. The results are summarized in the first two entries of Table 1, below.

Ozonation Following Pretreatment in Near-Critical Isobutane and n-Butane

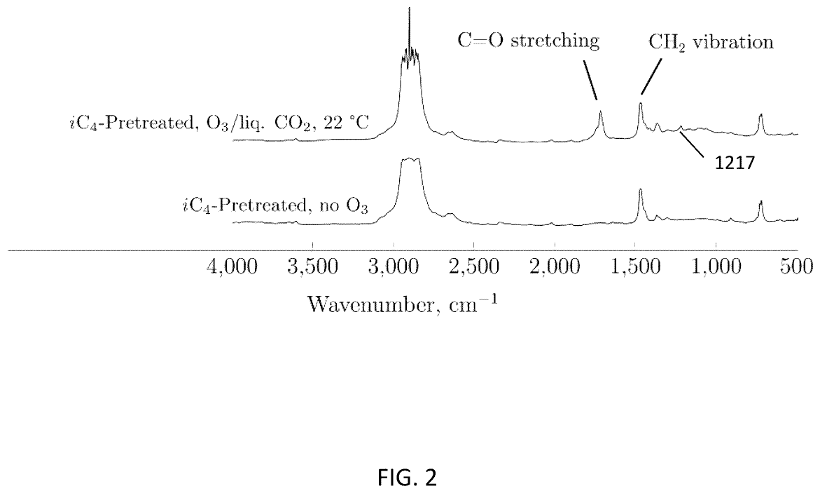

Sample pretreatment using isobutane (iC₄) and n-butane (nC₄) was carried out as described above, using a temperature of 120° C. and a time of 4 h. The vapor pressure of isobutane and n-butane at 120° C. is ˜400 psia (2.8 MPa) and ˜330 psia (2.2 MPa), respectively. The pretreated HDPE sample (˜51 mg) was loaded into the reactor for ozonation in liquid CO₂, 22° C., 915 psia. As before, 3.2 mmol ozone and 30.1 mmol dioxygen were charged into the reactor. Similar to the pretreatment with scCO₂, no soluble products could be detected by proton NMR from the methanol wash. However, formation of carbonyl groups in the pretreated HDPE samples was evidenced from the FTIR spectra (FIG. 2). The results for the iC₄ pretreated samples are summarized in the third entry of Table 1, below. Similar results were obtained for nC₄ pretreated samples.

### Ozonation Following Pretreatment in Hexane

Hexane has a higher critical temperature (T_{c}=234° C.) than n-butane (151° C.), isobutane (135° C.), and carbon dioxide (31° C.). After only 1 h pretreatment at ˜120° C. and 60 psi (0.41 MPa), the HDPE sample became dispersed in the liquid hexane, forming a suspension. Pretreatment temperatures of 110° C. and 100° C. were also used. Prior to ozonation, the solid sample was filtered, dried, and treated in vacuum at 60° C. for 4 h to remove any dissolved hexane.

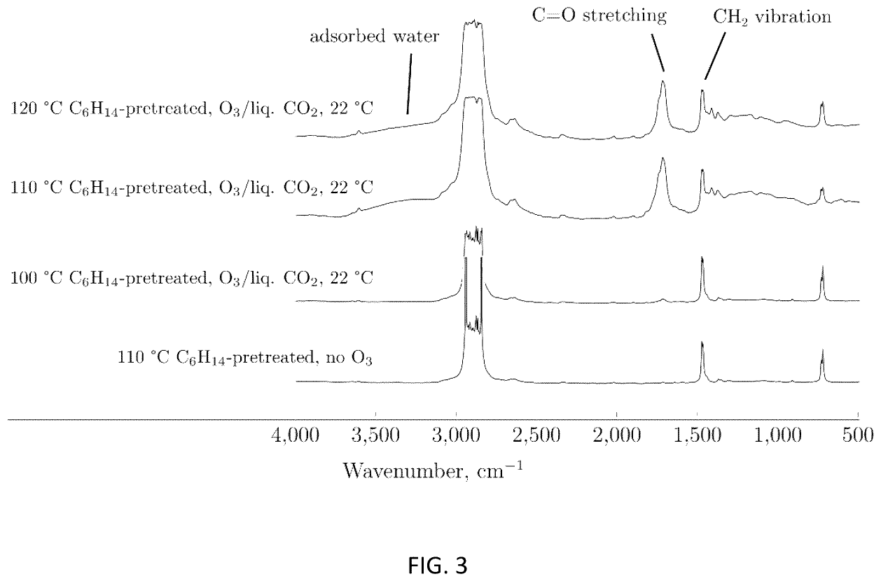

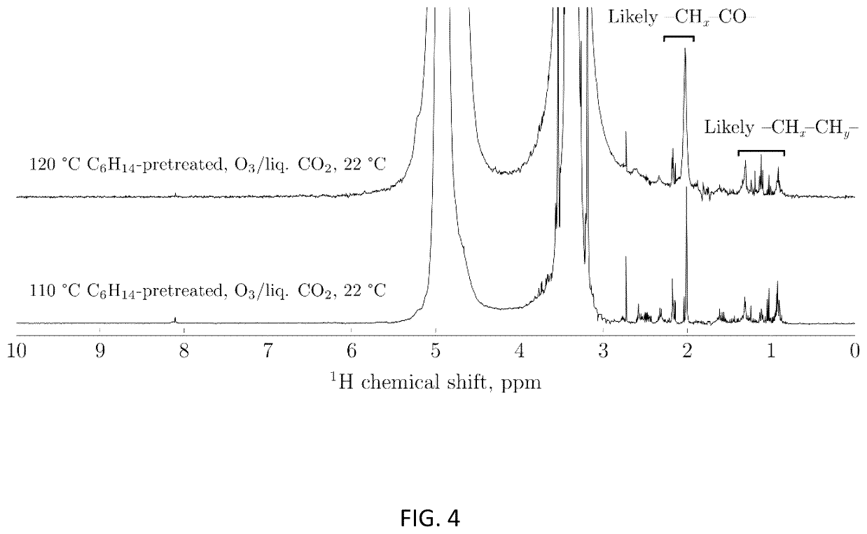

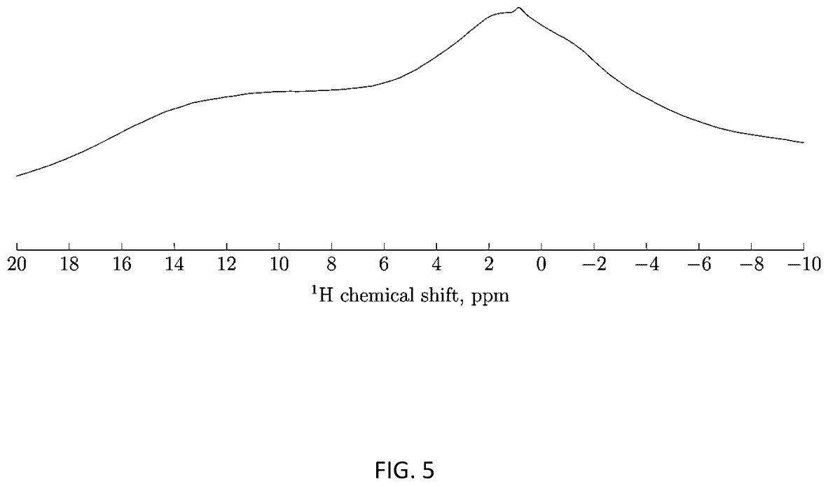

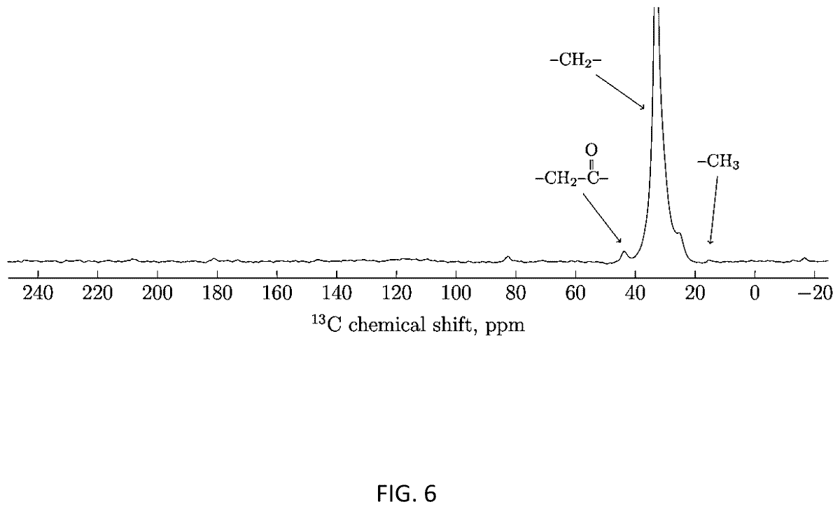

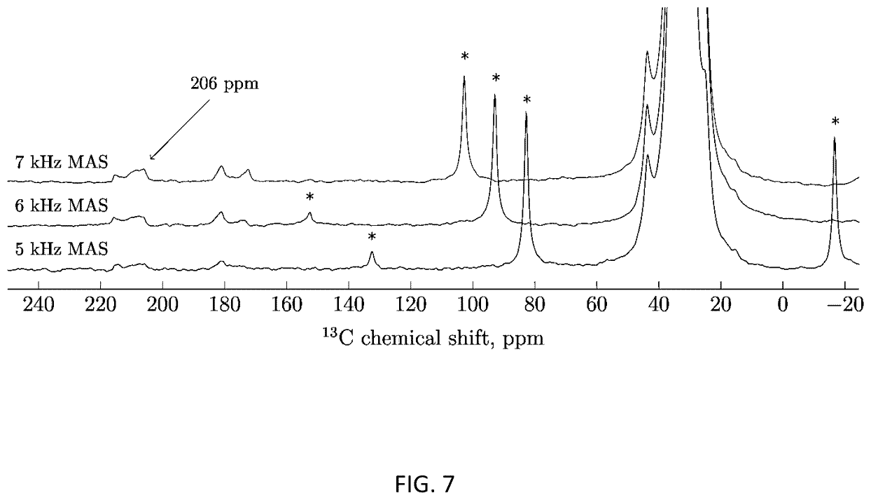

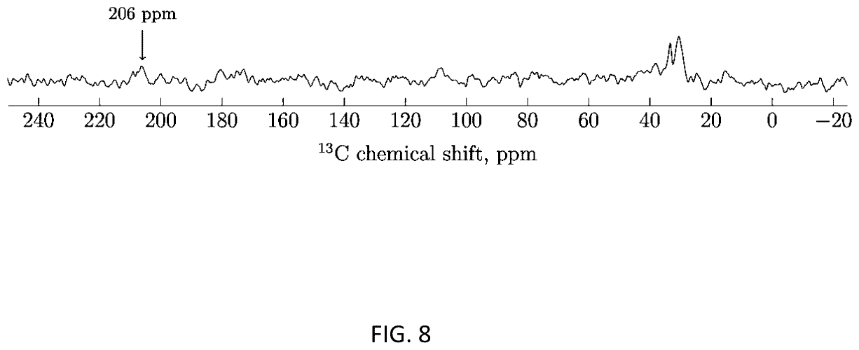

The pretreated HDPE sample (˜51 mg) was loaded into the reactor for ozonation in liquid CO₂, 22° C., 915 psia (6.3 MPa). As before, 3.2 mmol ozone and 30.1 mmol dioxygen were charged into the reactor. In this case, however, as compared to the previous experiments, significantly more carbonyl groups formed after ozonation as indicated by the relative scale of the 1700 cm⁻¹ band to the 1460 cm⁻¹ band (see FIG. 3). Further, the new broad bands in the 3000-3700 cm⁻¹ range were most likely adsorbed water, which suggests that ozonation may improve the hydrophilicity of the porous HDPE samples. The soluble products from the methanol wash of the ozonized products in the reactor were estimated to range from 10⁻¹-10⁻² mmol from the proton NMR spectra (FIG. 4). This indicates a low level of C—C cleavage, which may occur as a subsequent step following the functionalization. FIGS. 5-8 show the ¹H and ¹³C solid-state NMR spectra of the ozonized sample following pretreatment in hexane at 120° C. and 0.41 MPa. The CH₃ and CH₂ groups around 0.85 ppm and 1.2 ppm were predominant and masked any other signal in the ¹H spectrum (FIG. 5). In FIG. 6, branching CH groups were insignificant in the HDPE sample. In addition to the ¹³C signals around 15 ppm and 33 ppm associated with CH₃ and CH₂ groups, respectively, the signal around 43 ppm was likely due to α-CH₂ bonded to C═O. The spectrum also confirmed that branching CH groups were insignificant in the HDPE sample. However, in the ¹³C{¹H} cross-polarization spectra (FIG. 7), the signals around 170-180 ppm and 207-213 ppm were likely related to carboxyl and ketone carbonyl groups, respectively, which were also observed in FIGS. 6 and 8.

As noted above, pretreatment temperatures of 110° C. and 100° C. were also evaluated with hexane. By contrast to the pretreatment temperatures of 110° C. and 120° C., at 100° C., there was not a significant change in the physical appearance of the pretreated sample, and the IR spectra of the ozonized sample did not reveal a prominent carbonyl moiety (FIG. 3). The results for the pretreatment temperatures of 120° C. and 110° C. are shown in the fourth and fifth entries of Table 1, below.

### Gas-Solid Ozonation of Hexane-Pretreated HDPE Sample

About 253 mg of a sample that had been pretreated at 110° C. and 0.32 MPa in hexane for 1 h was loaded in the Parr reactor and exposed to a continuous stream of 8.6 mol % O₃ in O₂ flowing through the reactor at ˜70 sccm (no CO₂ present). The reactor was opened to sample a small amount (<15 mg) of the solid for analysis by FTIR spectroscopy. Upon 4 h exposure, the carbonyl index of the sample reached ˜0.92, indicating that ozonation of the methylene groups occurred even without using CO₂ as a carrier medium for ozone. The results are shown in the sixth entry of Table 1, below.

### Semi-Quantitative Comparison of the Degree of Functionalization

Due to the low density of carbonyl groups compared to the methylene groups, the C—H stretching bands usually saturate the range of the IR detector even when a reasonable signal for the C═O stretching may be recorded. The carbonyl index is defined as the area ratio of the C═O stretching bands around 1700 cm⁻¹ to those of the CH₂ vibration bands around 1460 cm⁻¹. This carbonyl index may be used to provide a semi-quantitative comparison of the degree of functionalization. The carbonyl indices for ozonized HDPE samples were calculated from FTIR spectra, and the results are listed in Table 1, below.

TABLE 1
Carbonyl indices of ozonized HDPE samples

| | | Carbonyl |
|---|---|---|
| Pretreatment conditions | Ozonation conditions | index |
| scCO₂, 120° C., 1500 psia | O₃/scCO₂, 50° C., 1150 psia | 0.24 |
| (10.3 MPa), 4 h | (7.9 MPa), 4 h | |
| scCO₂, 120° C., 1500 psia | O₃/liqCO₂, 22° C., 915 psia | 0.24 |
| (10.3 MPa), 4 h | (6.3 MPa), 4 h | |
| iC₄H₁₀, 120° C., 410 psia | O₃/liqCO₂, 22° C., 915 psia | 0.91 |
| (2.8 MPa), 4 h | (6.3 MPa), 4 h | |
| C₆H₁₄, 120° C., 60 psia | O₃/liqCO₂, 22° C., 915 psia | 1.47 |
| (0.41 MPa), 1 h | (6.3 MPa), 4 h | |
| C₆H₁₄, 110° C., 46 psia | O₃/liqCO₂, 22° C., 915 psia | 1.38 |
| (0.32 MPa), 1 h | (6.3 MPa), 4 h | |
| C₆H₁₄, 110° C., 46 psia | O₃ 22° C., 30 psia (0.2 MPa), | 0.92 |
| (0.32 MPa), 1 h | 4 h | |

### Example 2

### Introduction

This Example demonstrates the ozonation of post-consumer high-density polyethylene (HDPE) material that is pretreated in either hot alkanes or scCO₂ leading to melting point depression and increased porosity. The untreated semi-crystalline PE showed negligible oxidation by ozone. In contrast, the solvent pretreatment increased the accessibility of the macromolecules and significantly promoted the oxidation of secondary C—H bonds and the subsequent cleavage of C—C bonds in the materials at ambient temperature, leading to oxidative functionalization and degradation to produce carbonyl/carboxylic groups as confirmed by FTIR, NMR, and GPC analyses.

### Materials and Methods

n-Butane (chemically pure), isobutane (ultrahigh purity), and carbon dioxide (research purity) were purchased from Matheson. Hexane (C₆H₁₄ isomers>99%, n-hexane>95%) was purchased from Sigma-Aldrich. Alkanes and carbon dioxide were used without further purification. The high-density polyethylene (HDPE) materials (up to 0.7 mm thick) were from the containers of Walmart- and Kroger-brand distilled water. The containers were cleaned with a metal brush and Alconox detergent to remove the labels and possible contaminants on the surface and then washed with water and acetone. Negligible differences were observed in the FTIR spectra of the cleaned and solvent-pretreated materials from the two sources. The representative spectral results were obtained with the Kroger-brand containers. It was determined that the sample contained an average Cr mass fraction around 2×10⁻⁵ from the polymerization catalyst. (Zhu, H.; et al., ACS Catal. 2024, 14, 15633-15644.) The gel permeation chromatogram for the HDPE substrate may be fitted to two Gaussian peaks centered at 69 kDa and 266 kDa, and the overall polydispersity index was ˜12.7.

All the following pretreatment and ozonation experiments were performed in a 50 mL 4590 Series Parr reactor rated to 20.7 MPa and 350° C.

For pretreatment, the HDPE containers were cut into pieces of less than 0.3 cm², and about 0.2 g was loaded into the vessel. When either the butanes or scCO₂ (gases at ambient conditions) were used as the solvent pretreatment medium, each of these solvents was charged as liquid into the reactor using a cooled ISCO syringe pump (10° C.) after the reactor was assembled. When hexane was used as the solvent pretreatment medium, ˜30 mL of liquid was loaded into the vessel prior to attaching to the reactor head. The reactor content was heated to the desired temperature (70-120° C.) with stirring at 600 rpm and then held at the desired pressure (10.3 MPa for scCO₂, 2.8 MPa for butane, or 0.32/0.41 MPa for hexane) and temperature for a desired time (1 h for hexane, 1-2 h for butanes, and 1-24 h for CO₂). Immediately after the heater was switched off, the heating jacket was removed, and the reactor was quenched by ice to ˜50° C. within 5 min. If pretreated in hexane, the resulting samples were filtered, and the hexane was allowed to vaporize naturally. All of the samples were treated at 60° C. in vacuum for 4 h to remove any entrained solvent.

For ozonation, the HDPE sample was loaded into the Parr reactor. When liquid or supercritical CO₂ was used as the reaction medium, a desired amount of ozone/dioxygen mixture was charged into an external reservoir, and then a desired amount of CO₂ was charged as gas. The mixture was then injected into the reactor vessel with the cooled syringe pump. For gas-solid ozonation (i.e., without a solvent medium), the ozone/dioxygen mixture was simply charged into the closed vessel with the syringe pump. Following complete ozone conversion by 4 h, methanol was added to the vessel to dissolve any small-molecule products that may have formed.

For scanning electron microscopy (SEM) imaging, HDPE samples were mounted individually on sticky carbon tape on top of aluminum stubs and sputter coated with 5 nm gold using a SPI-Module Sputter Coater (SPI Supplies). Then, the samples were imaged using a S4700 II Cold Field Emission SEM instrument (Hitachi High Technologies) with lower and upper secondary electron detectors [SE(M)]. The data were acquired at normal operation mode: condenser lens at 5, 3 kV accelerating voltage, 5-10 μA emission current, aperture 2 (50 μm diameter), and 2560×1920 pixel resolution. The samples were also imaged using a Leica DMS300 Stereo Microscope at a 1600×1200 pixel resolution. The images from the Leica microscope were edited only to overlay the scale bars.

Due to the electrostatic attraction of the HDPE powder on the inner wall of the tubular section of the sample cell for N₂ sorption, the powder was flushed into the bulb of the 9 mm cell by pentane. The pentane was then vaporized at 30° C. (pentane vapor pressure=91.7 kPa) with argon flowing at ˜4 std cm³/min through a 1/16″ tubing, until the remaining pentane only wetted the powder. Then the remaining pentane was vaporized in a vented oven at 40° C. (above the pentane boiling point of 36.1° C.) overnight. Both cells containing the untreated and solvent-pretreated samples were evacuated at 3-5 mTorr (0.4-0.7 Pa) and 40° C. for 10 h on a Quantachrome Instruments Autosorb iQ. The N₂ sorption experiment was performed in a liquid N₂ bath at 77.4 K.

To establish a benchmark for comparison, semi-crystalline HDPE without solvent pretreatment was treated with ozone by continuously bubbling a mixture of 3.4 mol % O₃ in O₂ in various solvents at the conditions listed below. Samples as small as ˜2×0.7×0.7 mm³ were tested. In one configuration, a glass reactor equipped with magnetic stirring was operated at ambient pressure and 22° C. with no solvent or stirring. In the same reactor, ozonation runs were also performed with stirring at 600 rpm suspending the samples in either water at 22 and 50° C., acetic acid at 22° C., an acetic acid/water mixture (1:1 v/v) at 22° C., or NaOH/water (pH≈10), 22° C. In another configuration, a stainless-steel Parr reactor was operated at approximately 0.34 MPa, with mechanical stirring at 800 rpm. The HDPE samples were suspended in either water at 22° C. and 50° C. or in NaOH/water solution (PH≈10) at 22° C. In the last configuration, a stainless-steel Parr reactor with mechanical stirring at 800 rpm was used. The semi-crystalline HDPE sample was pretreated with scCO₂ at 70° C. and 10.3 MPa. Then CO₂ was partially displaced by an O₃/O₂/CO₂ mixture for the ozonation reaction in batch mode.

The samples were pressed into thin films around 0.1-0.2 mm using a Wabash hydraulic press for performing transmission FTIR measurement. A small quantity was placed in the mold that nearly covered the 8 mm bottom die. The mold was held under 56-58 MPa until the pressure changed negligibly over a 30 min duration. The spectra were collected using a Bruker Tensor 27 spectrometer equipped with an MCT detector, with an aperture size of 0.25 mm. The transmittance spectra were converted to absorbance and normalized to the film thickness measured by calipers.

Due to the drastically different densities of carbonyl and methylene groups compared to the methylene groups, the strongly-absorbing C—H stretching bands usually saturate the range of the IR detector when reasonable signal-to-noise ratios for C═O stretching bands may be recorded. This impedes reasonable comparison of the C═O stretching band against the C—H stretching band. Instead, the carbonyl index (CI) is defined as the area ratio of the C═O stretching bands around 1700 cm⁻¹ to the CH₂ scissoring bands around 1460 cm⁻¹. This carbonyl index may be used to provide a semi-quantitative comparison of the degree of functionalization.

The ¹H NMR spectra of the methanol-dissolved products were collected on a Bruker Avance III HD 400 MHz spectrometer. The solid-state NMR spectra were collected on a Bruker Avance III 400 MHz spectrometer with magic angle spinning (MAS) at 5 kHz unless otherwise mentioned. For 1H NMR, the “onepulse” pulse program was used. For ¹³C NMR using the “hpdec” pulse program, a recycle delay of 30 s was used. For the “cp” pulse program, a recycle delay of 4 s and a contact time of 1 ms were used.

Representative samples from the experiments were characterized by high-temperature gel permeation chromatography (HT-GPC) by PolyAnalytik Inc., using a Tosoh HLC-8321GPC/HT instrument following an established protocol for polyolefin analysis.⁴⁷ The molecular weight distributions were estimated with 95% confidence bands associated with the calibration curve.

### Results and Discussion

### Ozonation of Semi-Crystalline HDPE

In the case of ozone treatment of polyolefins without solvent pretreatment, no dissolved products could be detected when using water, methanol, or chloroform to wash the sample following reaction. FTIR spectra did not provide any evidence of functionalization of the ozone treated solid samples. It was therefore concluded that ozone was unable to penetrate the plastic matrix to any appreciable extent without pretreatment. These results were compared with those obtained following ozone treatment of samples pretreated with various solvents.

Ozonation Following Solvent Pretreatment HDPE in scCO₂

While retaining the form of a thin slab, the HDPE sample swelled, deformed, and showed less transparency (indicating increased porosity) after being treated in scCO₂ at ˜10.3 MPa and 120° C. for 4 h. The pretreated HDPE sample (˜50 mg) was loaded into the reactor for ozonation in either a liquid CO₂ medium at the ambient temperature of 22° C. or scCO₂ at 50° C. Ozone dissolves appreciably in liquid CO₂. The reactor was charged with 3.2±0.2 mmol of ozone and 30.9±2.1 mmol of dioxygen. After 4 h following the introduction of the mixture, no ozone was detected when CO₂ was discharged. No soluble products could be detected by proton NMR from the methanol wash of the ozone-treated sample. However, in the solid sample, formation of carbonyl groups was evidenced in the FTIR spectra (FIG. 1) when compared to the solvent-pretreated sample that was not exposed to ozone. It was also observed that reaction temperatures of 22 and 50° C. did not reveal any discernible changes in the extent of functionalization as inferred from FTIR spectra.

The foregoing results suggest that increasing the surface area (i.e., porosity) of the HDPE sample by solvent pretreatment can promote ozone accessibility. However, a scCO₂ phase may not be sufficiently dense at 120° C. to disentangle and disperse the polymer molecules. Light alkanes [hexane (P_{c}=3.02 MPa, T_{c}=234° C.) and isobutane (P_{c}=3.65 MPa, T_{c}=135° C.)] were evaluated as solvents for pretreatment of HDPE. The relatively low vapor pressures of such solvents also ensure that they can be easily removed in vacuo.

### Ozonation Following Solvent Pretreatment of HDPE in Near-Critical Isobutane

The sample pretreatment in isobutane (iC₄) was similar to that described with scCO₂, except that the vapor pressure of isobutane at 120° C. is 2.8 MPa. The isobutane-pretreated HDPE sample (˜51 mg) was loaded into the reactor for ozonation in a liquid CO₂ medium using a procedure similar to that in the previous section. As before, 3.2 mmol ozone and 30.1 mmol dioxygen were charged. Similar functionalization of the samples was observed upon ozonation as for those pretreated in scCO₂. No soluble products could be detected by proton NMR from the methanol wash of the ozone-treated solid. In the solvent-pretreated HDPE samples, FTIR spectra revealed the formation of carbonyl groups in the ozone-treated HDPE (FIG. 2). From a comparison based on carbonyl indices (described in a later section), C═O functionalization slightly increased for the isobutane-pretreated sample compared to the scCO₂-pretreated one. Further, in both cases, a small broad absorbance band around 1217 cm⁻¹ was observed which is likely associated with C—O stretching.

### Pretreatment of HDPE in Hexane and Characterization of the Resulting Material

Hexane has a higher critical temperature (T_{c}=234° C.) than isobutane (135° C.) and CO₂ (31° C.). After only 1 h pretreatment at ˜120° C. and 60 psi (0.41 MPa) following a procedure similar to that described above, the HDPE sample became dispersed as a suspension of particulates in the liquid hexane. This is in sharp contrast to the solvent pretreatment using either butane or scCO₂, wherein the HDPE samples more or less retained their shapes. The hexane-pretreated solid sample was filtered, dried, and treated in vacuum at 60° C. for 4 h to remove any dissolved hexane. The ¹H NMR spectrum of the filtrate indicated that the antioxidant content in the HDPE was either low or insignificantly leached by the hexane.

The SEM images of these samples are shown in FIG. 10. The untreated sample had a flat surface on which defects were evident at a magnification of 10 k. In contrast, the powder obtained from the hexane treatment was shown to be porous at magnifications of 50, 500, and 10 k.

The N₂ sorption data was obtained. The adsorption isotherms for empty and loaded cells shown in FIG. 11 have been normalized to the sample weights: 40.17 mg of powder HDPE and 167.2 mg of untreated HDPE. The isotherms show that the hexane-pretreated HDPE powder had a higher surface area for N₂ adsorption, while N₂ sorption on the untreated HDPE sample was below the detection limit of the instrument. As suggested by FIG. 10, the surface area of the untreated sample was expected to be close to its geometric surface area on the order of 10⁻³ m²/g (assuming HDPE density ≥0.95 g/cm³).

### Ozonation Following Solvent Pretreatment of HDPE in Hexane

An ozonation reaction was carried out with ˜51 mg of the hexane-pretreated HDPE sample in liquid CO₂ as the reaction medium at 22° C. Liquid CO₂ was charged into the reactor, followed by 3.2 mmol of O₃ and 30.9 mmol of O₂. Compared to the HDPE pretreated with either butanes or scCO₂, significantly more carbonyl groups formed after ozonation of hexane-pretreated HDPE as indicated by the relative scale of the 1700 cm⁻¹ band to the 1460 cm⁻¹ band²¹ (FIG. 3). Further, the new broad bands in the 3000-3700 cm⁻¹ range were most likely adsorbed water, which suggests that ozonation may improve the hydrophilicity of the porous HDPE samples. The soluble products from the methanol wash of the ozonized products in the reactor were estimated to range from 10⁻¹-10⁻² mmol from the proton NMR spectra (FIG. 4). This indicates that random scission of C—C bonds also occurred following ozone functionalization leading to the formation of shorter chains terminated by both carboxylic groups and small carboxylic acids. The occurrence of random scission was supported by HT-GPC characterization results as discussed in a later section.

FIG. 7 shows the ¹³C solid-state NMR spectra of the ozonized sample following pretreatment in hexane at 120° C. and 0.41 MPa. The CH₃ and CH₂ groups around δ 0.85 ppm and δ 1.2 ppm were dominant and masked other signals in the ¹H spectrum (FIG. 5). In FIGS. 5 and 6, branching CH groups were insignificant in the HDPE sample. In addition to the ¹³C signals around δ 15 ppm and δ 33 ppm associated with CH₃ and CH₂ groups, respectively, the signal around δ 43 ppm was attributed to α-CH₂ bonded to C═O. In the ¹³C{¹H} cross-polarization (CP) spectra (FIG. 7), the signals around δ 170-180 ppm and δ 207-213 ppm were attributed to carboxyl and ketone carbonyl groups of various proximity, respectively, which showed enhanced signal-to-noise ratios by CP compared to the decoupled spectrum in FIG. 6.

Pretreatment temperatures of 110 and 100° C. were evaluated when hexane was employed for solvent pretreatment of HDPE. There is not a significant change in the physical appearance of the hexane-pretreated sample at 100° C. except for minor swelling. The IR spectra of the ozonized sample following hexane pretreatment at 100° C. did not reveal a prominent carbonyl peak (FIG. 3). Thus, it appeared that a pretreatment temperature greater than 100° C. was essential for the HDPE sample, possibly to be partially solvated by n-hexane.

### Gas-Solid Ozonation of Hexane-Pretreated HDPE Sample

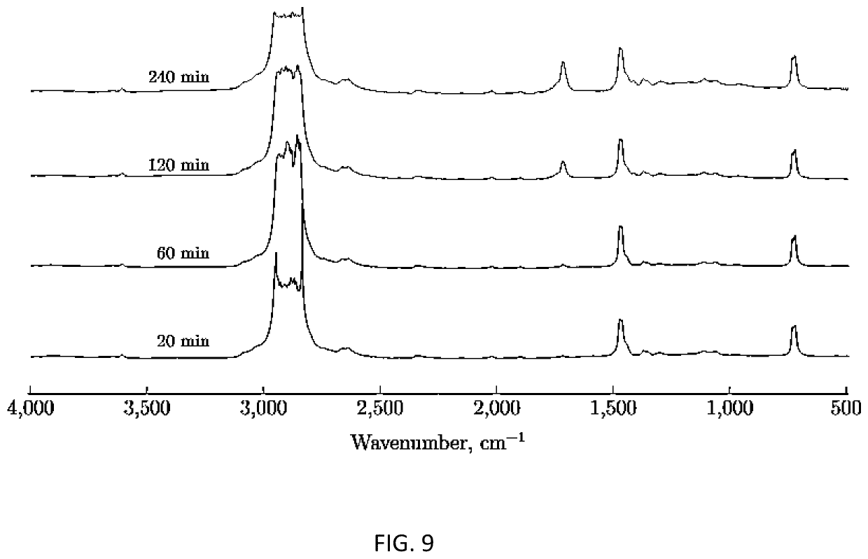

Approximately 253 mg of the sample that was pretreated at 110° C. and 0.32 MPa in hexane for 1 h was loaded in the Parr reactor and exposed to a continuous stream of 8.6 mol % O₃ in O₂ through the reactor at ˜70 std. cm³/min (no CO₂ present). The reactor was opened to sample a small amount (<15 mg) of the solid for analysis by FTIR spectroscopy (FIG. 9). Upon 4 h exposure, the carbonyl index of the sample reached ˜0.92 (Table 2, last row), indicating that ozonation of the methylene groups could occur even without employing liquid CO₂ as a reaction medium.

### Semi-Quantitative Comparison of the Degree of Functionalization

The carbonyl indices (defined as the peak area ratio of C═O stretching relative to that of C—H scissoring) for the ozonized HDPE samples were estimated from the FTIR spectra and the results are listed below in Table 2.

TABLE 2
Carbonyl indices of ozonized HDPE samples

| | | Carbonyl |
|---|---|---|
| Pretreatment conditions | Ozonation conditions | index |
| scCO₂, 120° C., 1500 psia | O₃/scCO₂, 50° C., 1150 psia | 0.24 |
| (10.3 MPa) | (7.9 MPa), 4 h batch | |
| scCO₂, 120° C., 1500 psia | O₃/liqCO₂, 22° C., 915 psia | 0.24 |
| (10.3 MPa) | (6.3 MPa), 4 h batch | |
| iC₄H₁₀, 120° C., 410 psia | O₃/liqCO₂, 22° C., 915 psia | 0.91 |
| (2.8 MPa) | (6.3 MPa), 4 h batch | |
| C₆H₁₄, 120° C., 60 psia | O₃/liqCO₂, 22° C., 915 psia | 1.47 |
| (0.41 MPa) | (6.3 MPa), 4 h batch | |
| C₆H₁₄, 110° C., 46 psia | O₃/liqCO₂, 22° C., 915 psia | 1.38 |
| (0.32 MPa) | (6.3 MPa), 4 h batch | |
| C₆H₁₄, 110° C., 46 psia | O₃/O₂, 22° C., 30 psia (0.2 | 0.92 |
| (0.32 MPa) | MPa), 4 h semi-continuous | |

Molecular Weight Distribution of HDPE Samples after Pretreatment and Ozonation

FIG. 12 compares the HT-GPC spectra of HDPE samples pretreated with various solvents and reacted with ozone under different conditions. The increased porosity induced by HDPE pretreatment with high-affinity solvents (such as hexane) allowed easier ozone access to —CH₂— groups in crystalline HDPE, while also facilitating the subsequent bond scission. Such C—C bond cleavage likely resulted in the formation of carboxylic-group-terminated molecules with molecular weight distributions reduced by approximately 10^{-2.5} to 10⁻¹ (FIGS. 12, traces B-D) compared to those of the HDPE substrate (FIG. 7, trace A). The GPC results show that the molecular weight distribution can be further tuned by the porosity generated during the pretreatment in various solvents (isobutane versus n-hexane) and the ozonation conditions (O₃ gas versus O₃ in liquid CO₂). These results thus demonstrate a technique that enables end-of-life polyethylene containing predominantly methylene groups to form dicarboxylic acids <C₂₀ that may be separated and used as precursors to produce polyester materials.

### Ozone Utilization

Competing ozone decomposition by radicals diminishes its utilization toward —CH— bond activation. Ozone decomposition can be promoted by radicals as demonstrated. As the extent of oxyfunctionalization increases at higher surface areas, the probability of the formation of alkoxyl radicals also increases. However, in contrast to ozonation of —CH₂— groups in the liquid phase, such radicals are drastically less mobile on a solid surface and cannot abstract H from other CHₓ groups as easily as in a liquid phase. On a solid surface, such radicals are readily accessible by gaseous ozone causing its decomposition and thereby reducing its utilization toward CHₓ activation. To demonstrate this, another HDPE sample corresponding to the pretreatment conditions noted in Table 2 (Row 4) was treated but with substantially more ozone (O₃/CH₂˜60) than the stoichiometric amount of unity. Yet, the carbonyl index increased to only ˜2.5 for the second sample because of low O₃ utilization. In addition to the increase in C═O stretching in the second sample (treated with more ozone), increases in the bands around 1200 cm⁻¹ (likely C—O stretching) indicated further oxidation to ester or anhydride groups (data not shown). These results show that optimization aimed at maximizing the extent of oxy-functionalization through may be achieved through the efficient use of ozone.

### CONCLUSION

This Example demonstrates a straightforward technique for functionalizing high-density polyethylene (HDPE) using ozone. The method involved pretreating the polymer in either supercritical carbon dioxide or paraffinic solvents such as isobutane or n-hexane at 110-120° C. followed by ozonation of the porous polymer at ambient temperature in liquid carbon dioxide. Nitrogen sorption, SEM micrographs and DSC profiles confirmed that solvent pretreatment induced porosity in HDPE without significantly affecting its crystallinity. Infrared and NMR analyses revealed increased formation of carbonyl groups in the polymer sample pretreated by n-hexane compared to other solvents. The virtual lack of porosity in the untreated HDPE sample prevented facile ozonation. The significant porosity created in the HDPE following solvent pretreatment increased ozone accessibility, resulting in enhanced formation of oxygenated functional groups. High temperature GPC analyses indicated that the pretreated HDPE samples underwent deconstruction upon ozone treatment, with the hexane-pretreated sample showing the most activity. This suggests that ozone treatment also induced C—C scission as supported by the presence of carboxylic acid groups in the NMR spectra. This functionalization technique admits the principles of green chemistry such as the use of benign reagents to introduce porosity, edit polymers, and potentially recycle/upcycle them post use. The ozonized materials may be subsequently modified using established methods to either deconstruct, oxidize, or edit carbonyl/ester groups.

Additional information relating to Examples 1 and 2 may be found in U.S. Provisional Patent Application No. 63/660,740, filed Jun. 17, 2024, the entire contents of which are incorporated herein by reference.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

Unless otherwise indicated, and in recognition of the inherent nature of the techniques described herein, throughout the present disclosure, terms and phrases such as “absence,” “free,” “does not comprise,” etc. encompass, but do not require a perfect absence of the referenced entity.

Unless otherwise indicated, the term “type” as used herein refers to chemical formula such that a single type means the same chemical formula and different type means different chemical formula. Similarly, use of “more” as in “one or more” refers to use of different types of the relevant entity.

Unless otherwise indicated, throughout the present disclosure, terms such as “comprising” and the like may be replaced with terms such as “consisting” and the like.

What is claimed is:

1. A process for functionalizing a polyolefin, the process comprising:
(a) exposing a polyolefin to an alkane swelling agent under conditions to form a pretreated polyolefin; and
(b) exposing the pretreated polyolefin to ozone under conditions to oxidize the pretreated polyolefin to form a functionalized polyolefin.

2. The process of claim 1, further comprising (c) removing the alkane swelling agent from the pretreated polyolefin of step (a) prior to step (b).

3. The process of claim 1, wherein the polyolefin is selected from polyethylene, polypropylene, polyisobutylene, and combinations thereof.

4. The process of claim 3, wherein the polyethylene is high-density polyethylene (HDPE), low density polyethylene (LDPE), linear low-density polyethylene (LLDPE), very low-density polyethylene (VLDPE), ultra-high molecular weight polyethylene (UHMWPE), or a combination thereof and the polypropylene is high-density polypropylene (HDPP), low-density polypropylene (LDPP), atactic polypropylene, syndiotactic polypropylene, isotactic polypropylene, or a combination thereof.

5. The process of claim 1, wherein the polyolefin is HDPE or HDPP.

6. The process of claim 1, wherein the alkane swelling agent is selected from linear alkane swelling agents, branched alkane swelling agents, cyclic alkane swelling agents, and combinations thereof.

7. The process of claim 1, wherein the alkane swelling agent is butane, pentane, hexane, or a combination thereof.

8. The process of claim 1, wherein the alkane swelling agent is hexane.

9. The process of claim 8, wherein the hexane is n-hexane.

10. The process of claim 1, wherein the pretreated polyolefin is porous.

11. The process of claim 1, wherein step (a) comprises use of a pretreatment temperature greater than room temperature and less than a melting temperature of the polyolefin free of the alkane swelling agent; and a pretreatment pressure greater than atmospheric pressure.

12. The process of claim 11, wherein the pretreatment temperature is in a range of from 100° C. to 125° C. and the pretreatment pressure is in a range of from 0.2 MPa to 5 MPa.

13. The process of claim 2, wherein step (c) further comprises cooling the pretreated polyolefin prior to step (b).

14. The process of claim 1, wherein the ozone is provided in an ozonation medium consisting of ozone, the pretreated polyolefin, and optionally, a gas used to deliver the ozone, a catalyst, or both.

15. The process of claim 1, wherein the ozone is provided in an ozonation medium comprising ozone and CO₂.

16. The process of claim 15, wherein the CO₂ is liquid CO₂.

17. The process of claim 15, wherein the CO₂ is supercritical CO₂.

18. The process of claim 15, wherein the ozonation medium consists of the ozone, the CO₂, the pretreated polyolefin, and optionally, a gas used to deliver the ozone, a catalyst, or both.

19. The process of claim 1, wherein the functionalized polyolefin comprises carbonyl functionalized polyolefin.

20. The process of claim 19, wherein the carbonyl functionalized polyolefin exhibits a carbonyl index of at least 0.9.
